(19) United States
(12) Patent Application Publication
(10) Pub. No.: US 2025/0229840 A1
(43) Pub. Date: Jul. 17, 2025

(54) VEHICLE

(71) Applicant: KAWASAKI MOTORS, LTD., Akashi-Shi (JP)

(72) Inventors: Kota HIDAKA, Akashi-Shi (JP); Kouji ITOU, Akashi-Shi (JP); Daisuke SAEKI, Lincoln, NE (US)

(73) Assignee: KAWASAKI MOTORS, LTD., Akashi-Shi (JP)

(21) Appl. No.: 18/412,673

(22) Filed: Jan. 15, 2024

(51) Int. Cl. B62D 25/12; B60Q 1/04; B60R 5/02; B60R 11/02; B62D 25/14

(52) U.S. Cl. CPC B62D 25/12; B60Q 1/04; B60R 5/02; B60R 11/0217; B62D 25/14

(57) ABSTRACT

A vehicle includes a storage forming component, a hood, and at least one electrical component. The storage forming component is disposed in a front portion of the vehicle, the storage forming component including a storage. The hood covers the storage. The at least one electrical component is covered by the hood.

### BACKGROUND OF THE INVENTION

### Field of the Invention

This disclosure relates to a storage structure in a vehicle.

### Background Art

Each of US2021/0086840 A1 and US2022/0371519 A1 discloses a technology of disposing a storage in a front portion of a vehicle.

Each of US2022/0063734 A1 and US2006/0202503 A1 discloses a technology of disposing a storage in a rear portion of a vehicle.

### SUMMARY

This vehicle includes: a storage forming component disposed in a front portion of the vehicle, the storage forming component including a storage; a hood covering a top of the storage; and at least one electrical component covered by the hood.

Opening the hood in this vehicle can access not only the storage but also the electrical component.

The objects, features, aspects, and advantages of this disclosure will become more apparent from the following detailed description and the accompanying drawings.

### BRIEF DESCRIPTION OF THE DRAWINGS

FIG. 1 is a side view illustrating a vehicle according to an embodiment.

FIG. 2 is a perspective view illustrating a front portion of the vehicle in FIG. 1.

FIG. 3 is a perspective view illustrating the front portion of the vehicle in FIG. 1.

FIG. 4 is a plan view illustrating the front portion of the vehicle in FIG. 1.

FIG. 5 is a plan view illustrating the front portion of the vehicle in FIG. 1.

FIG. 6 illustrates a lower surface of a hood.

FIG. 7 illustrates a cross-sectional view taken along the line VII-VII of FIG. 4.

FIG. 8 illustrates a cross-sectional view taken along the line VIII-VIII of FIG. 4.

FIG. 9 illustrates a state in which a speaker device is housed in a storage.

FIG. 10 illustrates a modification of a receiving part of a hood.

FIG. 11 illustrates that a hood supporter of a storage forming component supports the receiving part of the hood.

### DESCRIPTION OF THE PREFERRED EMBODIMENTS

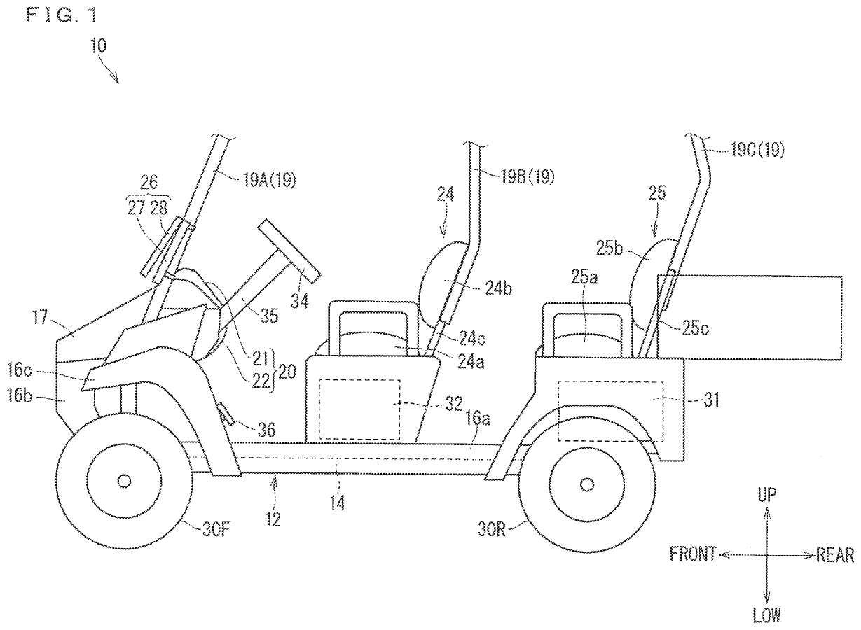

A vehicle according to an embodiment will be hereinafter described. FIG. 1 is a side view illustrating a vehicle 10 according to the embodiment. In the following description, traveling directions of the vehicle 10 may be expressed as forward, backward opposite to the forward direction, downward toward road surfaces on which the vehicle 10 travels, and upward opposite to the downward direction. The right and left may be referred to while a person stands on a road surface and faces forward. The lateral direction is a vehicle-width direction.

The vehicle 10 may be a single-seater vehicle or a multi-seater vehicle. The vehicle 10 may have only a seat or seats in a forward and backward direction. Since the vehicle 10 is a vehicle designed to travel through, for example, private roads or private lands at low speeds, the vehicle 10 may have open right and left passenger entrances to seats without being obstructed by walls or doors to facilitate the occupants getting on or off the vehicle 10. Here, the occupants can walk past in a lateral direction without being obstructed by doors or walls.

### [Overall Structure of Vehicle]

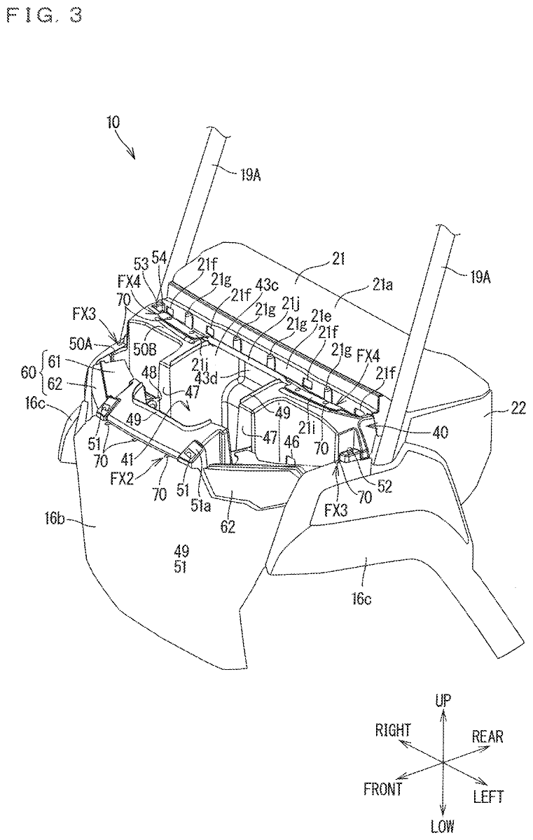

The vehicle 10 includes a car body 12 including a hood 17, a storage forming component 40 (see FIG. 3), and electrical components 60 (see FIG. 3). The vehicle 10 according to the embodiment further includes seats 24 and 25, a traveling mechanism, and a driving operation mechanism.

The car body 12 may have a frame structure or a monocoque structure. This embodiment will be described assuming that the car body 12 has a frame structure. The car body 12 includes a frame 14 and panels. The frame 14 is structured by combining, for example, metallic pipe components, sheet metal components, or cast components. The panels cover the frame 14 and various components supported by the frame 14. The panels give the appearance of the vehicle 10, and partition spaces in the vehicle 10. Examples of the panels include a floor panel 16a, a front panel 16b, side panels 16c, the hood 17, and a dashboard 20.

The floor panel 16a is disposed under the occupant space in which a driver and an occupant are located. The dashboard 20 is disposed in a front end of the occupant space. The dashboard 20 functions as a partition that separates the occupant space from a front internal space located more forward than the occupant space. The front panel 16b and the side panels 16c are disposed in a front portion of the vehicle 10. The front panel 16b and the side panels 16c give the appearances of the front surface and the side surfaces of the vehicle 10, respectively. The front panel 16b is disposed in a portion including a middle of the vehicle 10. The pair of the side panels 16e are disposed at both sides of the vehicle 10. The front panel 16b functions as a partition that partitions the front of the front internal space. The side panels 16c function as partitions that partition the sides of the front internal space.

The hood 17 is located more forward than the dashboard 20. The hood 17 functions as a partition that partitions above the front internal space. The front panel 16b is located more forward than the hood 17. The pair of the side panels 16c are located at both outside portions of the hood 17 in the lateral direction. The storage forming component 40 is disposed under the hood 17. The storage forming component 40 holds the electrical components 60.

The dashboard 20 may include an instrument panel, a glove box, various switches, and an indicator. The dashboard 20 according to the embodiment includes an upper surface portion above a floor panel region on which toes of the driver and the occupant are placed.

The dashboard 20 includes, for example, an upper dashboard 21 and a lower dashboard 22. For example, the upper dashboard 21 and the lower dashboard 22 are resin parts separately formed. The upper dashboard 21 is a front and upper portion of the dashboard 20. The lower dashboard 22 is a rear and lower portion of the dashboard 20. The external surface of the upper dashboard 21 faces upward. The external surface of the lower dashboard 22 faces rearward.

Each of the seats 24 and 25 is a part on which occupants are to be seated. The seats 24 and 25 are located on the floor panel 16a. The car body 12 supports the seats 24 and 25. The seats 24 and 25 are apart from each other in the forward and backward direction. The seat 24 is located more forward than the seat 25. The seat 24 includes a seat cushion 24a, a back rest cushion 24b, and a seat frame 24c. Similarly, the seat 25 includes a seat cushion 25a, a back rest cushion 25b, and a seat frame 25c. The seat frames 24c and 25c can be considered as parts of the frame 14 in the car body 12. Outside right and left portions of the seats 24 and 25 are openings through which occupants get on and off the vehicle 10. The vehicle 10 is intended to normally travel with the openings being opened and not closed by, for examples, doors.

The seats 24 and 25 are bench seats on which persons can be seated side by side in the vehicle-width direction. A driver seat on one side in the vehicle-width direction and an assistant driver seat on the other side in the vehicle-width direction are disposed to sandwich the middle of the vehicle 10 in the vehicle-width direction. Here, a portion of the seat 24 on one side with respect to the middle in the vehicle-width direction is considered as the driver seat, and a portion of the seat 24 on the other side is considered as the assistant driver seat. The seat 24 may have a structure in which the driver seat and the assistant driver seat are independently provided.

The traveling mechanism is a mechanism for traveling of the vehicle 10, and includes wheels 30F and 30R, a traveling motor 31, and a power transmission mechanism. Transmission of rotation drive force of the traveling motor 31 to the wheels 30F and 30R through the power transmission mechanism allows the vehicle 10 to travel. This embodiment describes an example in which the vehicle 10 includes the four wheels 30F and 30R. The vehicle 10 may include three or six wheels. The structure of the power transmission mechanism is discretionary. Examples of the power transmission mechanism may include a transmission and a drive shaft.

The wheels 30F and 30R include front wheels 30F and rear wheels 30R, respectively. The two front wheels 30F are rotatable around its own central axis and are supported to be rotatable around a steering axis, at right and left front portions of the car body 12. The two rear wheels 30R are supported to be rotatable around its own central axis at right and left rear portions of the car body 12.

In this embodiment, the traveling motor 31 is an electric motor that converts electric energy into rotational motion for traveling. H-ere, the vehicle 10 includes a traveling battery 32 for supplying the electric energy to the traveling motor 31. For example, the traveling battery 32 is supported at a lower portion of the seat 24, and the traveling motor 31 is supported at a lower portion of the seat 25. The traveling motor 31 may be an internal combustion engine that burns fuel in a combustion chamber and generates power for traveling through expansion of gases from the burnt fuel. Here, the vehicle 10 should include a fuel tank. The positions of the traveling motor 31 and the traveling battery 32 are discretionary.

The driving operation mechanism is a mechanism for receiving a driving operation from the driver, and includes, for example, a steering wheel 34 and pedals 36. The operation of the steering wheel 34 by the driver enables the front wheels 30F to rotate around the steering axis. The driver can operate an accelerator and a brake through operations of the pedals 36. The steering wheel 34 and the pedals 36 are located more forward than the seat 24. The driver seated on the seat 24 can operate the steering wheel 34 and the pedals 36. For example, a steering column 35 protrudes rearward from the dashboard 20, and the steering wheel 34 is supported at the end of the steering column 35. The pedals 36 are located below the steering wheel 34. The pedals 36 may be an accelerator pedal and a brake pedal that are separately provided. One pedal may operate both of the accelerator and the brake.

The vehicle 10 according to this embodiment includes pillars 19. Pairs of the pillars 19 are disposed at both sides, and upper ends of each of the pairs are connected through a cross portion. The pillars 19 herein include front pillars 19A, center pillars 19B, and rear pillars 19C. The front pillars 19A extend upward from both sides of the dashboard 20. The upper surface portion of the dashboard 20 protrudes more rearward than the pillars 19A. The center pillars 19B extend upward from the back rest of the seat 24. The rear pillars 19C extend upward from behind the back rest cushion 25b of the seat 25. The upper ends of the pillars 19A, 19B, and 19C may be connected through cross portions. The center pillars 19B or the rear pillars 19C may extend from, for example, a floor portion except the seats 24 and 25. The number of the pillars 19 is discretionary. For example, the center pillars 19B may be omitted.

The vehicle 10 according to this embodiment includes a windshield 26. The windshield 26 is connected to the pillars 19A. In the example of FIG. 1, the windshield 26 is divided into a first shield 27 and a second shield 28. The first shield 27 is connected to the pillars 19A. The second shield 28 is rotatably coupled to the first shield 27 through a hinge. The user can rotate the second shield 28 as necessary.

A roof, which is not illustrated, may be supported at upper portions of the pillars 19. In this case, the vehicle 10 may include the roof. The roof spreads to cover the seats 24 and 25 from the top, above the seats 24 and 25. The roof can provide the occupants with a sunshade and a weather shield. The roof may spread in the forward and backward direction from a position in front of the steering wheel 34 toward a position behind the back rest of the seat 25. The roof may spread to cover the whole of the seats 24 and 25 in the lateral direction.

### [Front Structure of Vehicle]

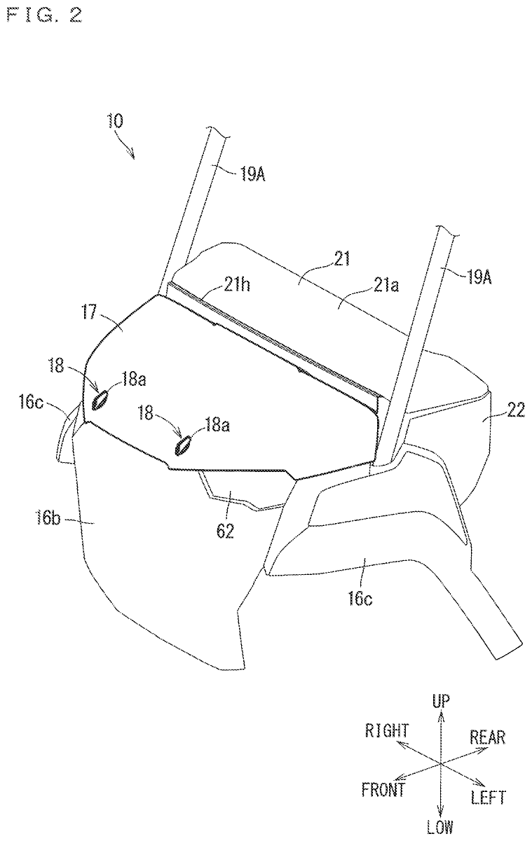

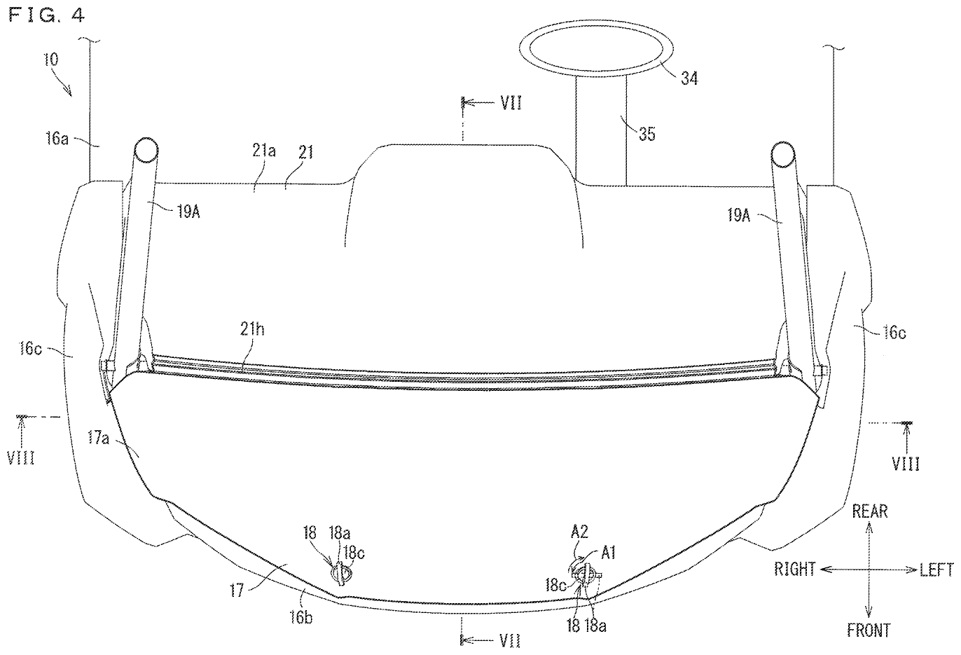

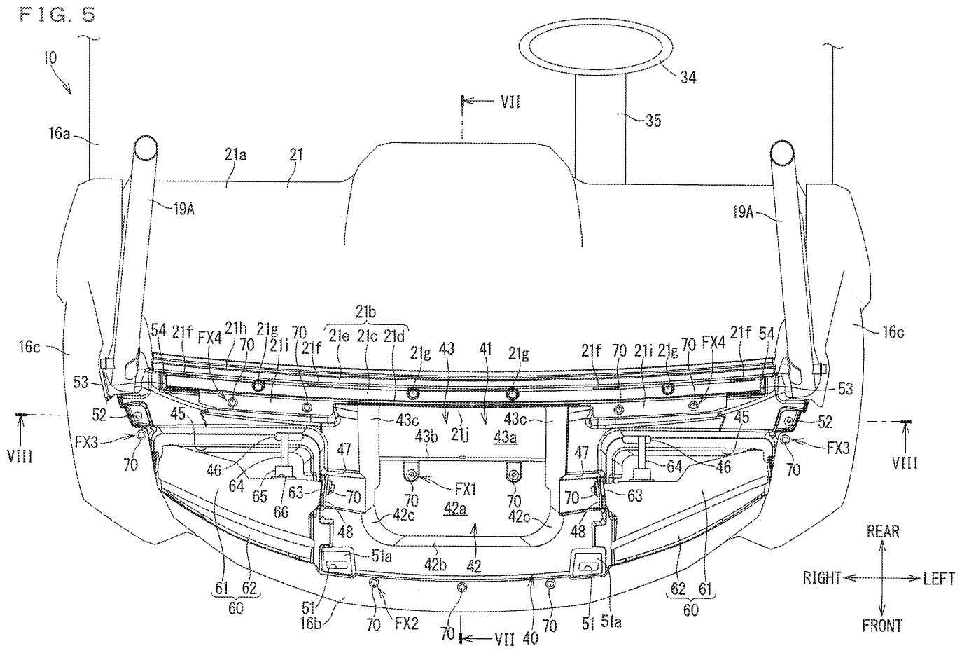

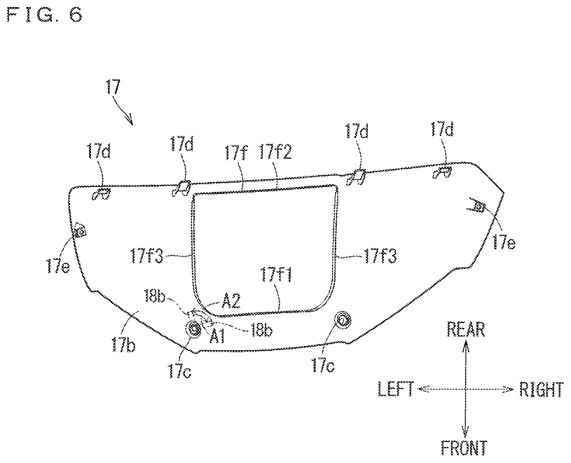

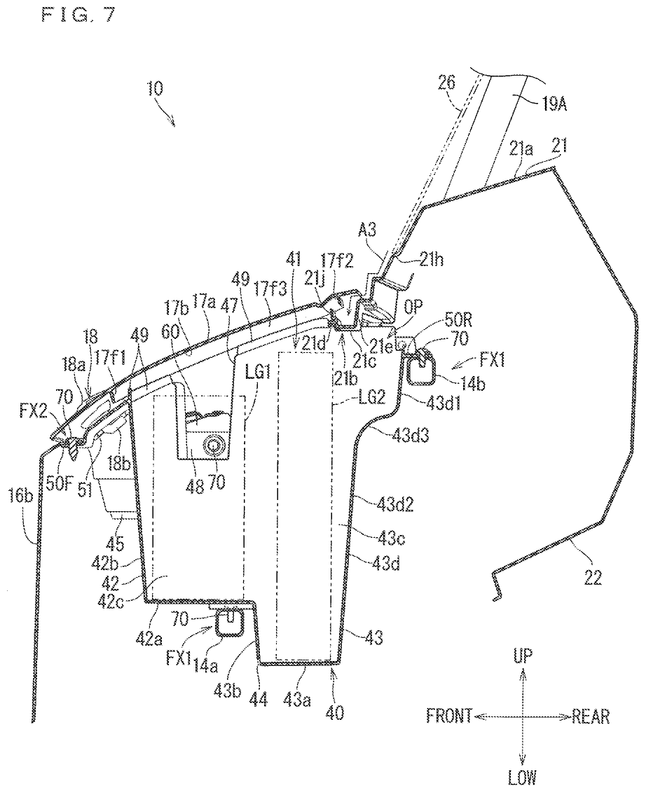

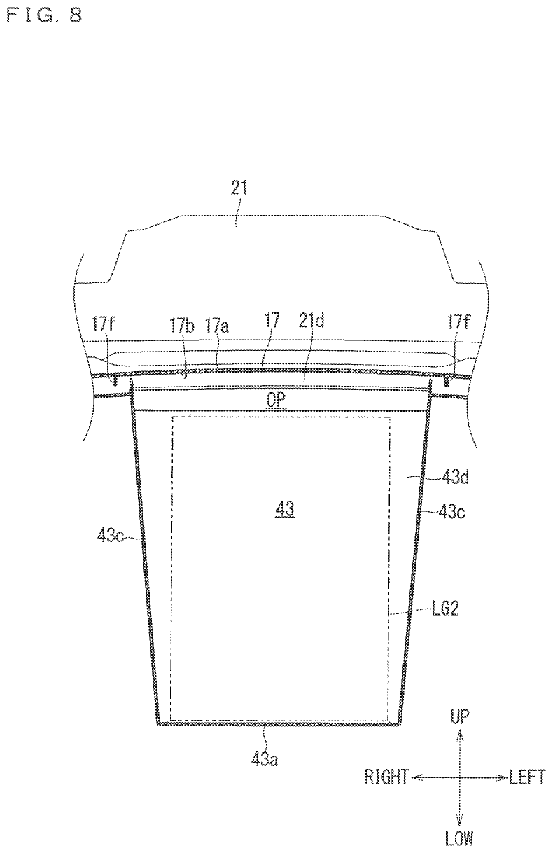

A front structure of the vehicle 10 including the storage forming component 40 and the electrical components 60 will be described more in detail. FIGS. 2 and 3 are perspective views each illustrating the front portion of the vehicle 10 in FIG. 1. FIGS. 4 and 5 are plan views each illustrating the front portion of the vehicle 10 in FIG. 1. FIGS. 2 and 4 illustrate the presence of the hood 17, and FIGS. 3 and 5 illustrate the absence of the hood 17. FIG. 6 illustrates a lower surface 17b of the hood 17. FIG. 7 illustrates a cross-sectional view taken along the line VII-VII of FIG. 4. FIG. 8 illustrates a cross-sectional view taken along the line VIII-VIII of FIG. 4. The line VII-VII and the line VIII-VIII in FIG. 5 are drawn at identical locations of those in FIG. 4.

In the front portion of the vehicle 10, the storage forming component 40 and the electrical components 60 are disposed in the front internal space enclosed by the front panel 16b, the side panels 16c, the hood 17, and the dashboard 20. The storage forming component 40 includes a storage 41. The storage 41 is formed as a blind hole that is recessed downward. The storage 41 may be free space for the occupants. As illustrated in FIG. 7, the storage 41 may house, for example, bags LG1 and LG2 of the occupants. The storage 41 may be space for housing optional equipment of the vehicle 10.

The hood 17 covers the top of the storage 41 and the electrical components 60. The hood 17 has an upper surface 17a and the lower surface 17b. The lower surface 17b of the hood 17 faces the storage 41 and the electrical components 60 while the hood 17 is closed. The occupants can access the storage 41 and the electrical components 60 by opening the hood 17. The storage. 41 and the electrical components 60 are exposed while the hood 17 is opened. At least a part of the electrical components 60 overlaps the hood 17 in a plan view. The electrical components 60 may or need not overlap the storage forming component 40 in a plan view. When the electrical components 60 overlap the storage forming component 40 in a plan view, the electrical components 60 should be located above the storage forming component 40.

The storage forming component 40 herein includes electrical component holders 45. The electrical component holders 45 hold the electrical components 60. The electrical component holders 45 are formed as blind holes that are recessed downward, similarly to the storage 41. The electrical component holders 45 support the electrical components 60 from the bottom. The electrical components 60 herein include a pair of right and left headlights 60. The electrical component holders 45 include a pair of right and left headlight holders 45 for holding the pair of right and left headlights 60. The electrical component holders 45 may hold electrical components except the headlights 60. The storage 41 is located between the pair of right and left electrical component holders 45.

Each of the headlights 60 includes, for example, a light body 61 including a light source, and a front cover 62 allowing the light transmitted frontward from the light source to pass through. The front cover 62 may or need not have a function as a lens that diffuses light. The light body 61 is fixed to the electrical component holder 45. Openings for forwardly exposing the front covers 62 in the vehicle 10 are formed between the front panel 16b and the hood 17. The light body 61 includes a fastening part 63 to be fastened to the storage forming component 40. Cables 64 are connected to the light bodies 61. The cables 64 include, for example, an electric power line that supplies the power to the light source, and a signal line that controls emission of light from the light source. For example, a connector 65 at the end of each of the cables 64 is connected to a counterpart connector 66 at a rear portion of the light body 61. A through hole 46 through which the cable 64 passes is formed on a rear wall of the electrical component holder 45.

The storage 41 includes a first storage 42 and a second storage 43. Here, the first storage 42 and the second storage 43 are disposed side by side in the forward and backward direction. The first storage 42 and the second storage 43 may be disposed side by side in the vehicle-width direction.

Specifically, the first storage 42 includes a first bottom portion 42a, a first front wall 42b, and first side walls 42c. The first front wall 42b extends upward from a front edge of the first bottom portion 42a. The first side walls 42c extend upward from both side edges of the first bottom portion 42a.

The second storage 43 includes a second bottom portion 43a, a second front wall 43b, second side walls 43c, and a rear wall 43d. The second front wall 43b extends upward from a front edge of the second bottom portion 43a. The upper end of the second front wall 43b is connected to the rear end of the first bottom portion 42a. The second front wall 43b does not protrude upward beyond the first bottom portion 42a. Thus, the first storage 42 and the second storage 43 are not partitioned in the forward and backward direction. The second front wall 43b may protrude upward beyond the first bottom portion 42a, and the first storage 42 and the second storage 43 may be partitioned in the forward and backward direction. The second side walls 43c extend upward from both side edges of the second bottom portion 43a. The rear wall 43d extends upward from a rear edge of the second bottom portion 43a. An upper portion 43d1 of the rear wall 43d is located more rearward than a lower portion 43d2 of the rear wall 43d. The rear wall 43d includes a bent portion 43d3 that offsets the upper portion 43d1 more rearward than the lower portion 43d2. The rear wall 43d may extend uniformly straight from the lower portion 43d2 toward the upper portion 43d1.

The second storage 43 is higher than the first storage 42. Here, the second bottom portion 43a is lower than the first bottom portion 42a. This makes the second storage 43 higher than the first storage 42. Making the second storage 43 higher enables the bag LG2, which is longer than the bag LG1 that can be housed in the first storage 42, to be housed in the second storage 43 as illustrated in FIG. 7. The storage 41 need not include the first storage 42 and the second storage 43. The storage 41 may be formed so that the first bottom portion 42a and the second bottom portion 43a have the same height.

Here, a portion of the hood 17 which covers the storage 41 extends from the lower front toward the upper rear. Thus, a portion of the hood 17 which covers the second storage 43 is higher than a portion of the hood 17 which covers the first storage 42. This also makes the second storage 43 higher than the first storage 42.

As illustrated in FIG. 7, the storage 41 includes a drainage hole 44. Thus, the water accumulated in the storage 41 can be drained through the drainage hole 44. Here, the drainage hole 44 is formed in a joint portion between the second bottom portion 43a and the second front wall 43b with respect to the middle of the second storage 43 in the width direction. Here, the second bottom portion 43a is a sloped surface whose front portion is lower than its rear portion. The storage 41 need not include the drainage hole 44, When the storage 41 includes the drainage hole 44, the drainage hole 44 may be formed in a location except the aforementioned location.

The storage forming component 40 includes a waterproof wall 48 that partitions the storage 41 and the electrical component holders 45. Here, a recess 47 is formed along each of the first side walls 42c. The recess 47 is recessed downward from the upper end of the first side wall 42c. The bottom of the recess 47 is in a middle portion of the first side wall 42c in a height direction. The waterproof wall 48 is formed at the bottom of the recess 47. The height of the waterproof wall 48 is smaller than the depth of the recess 47. The upper end of the waterproof wall 48 is lower than the upper end of the first side wall 42c.

The electrical components 60 are fixed using the waterproof wall 48. Fixing holes for fixing the electrical components 60 are formed in the waterproof wall 48. A fastening component 70 such as a bolt or a rivet is fastened to each of the fixing holes. The fastening parts 63 of the light bodies 61 are fastened to the waterproof wall 48.

The storage forming component 40 is connected to the car body 12. A portion to which the storage forming component 40 is connected in the car body 12 may be, but not exclusively, for example, the frame 14. Locations of connecting portions between the storage forming component 40 and the frame 14 (hereinafter referred to as “frame connecting portions FX1”) can be, but not exclusively, appropriately set. Here, the frame connecting portions FX1 are formed in an inner portion of the storage 41 and a rear portion of the storage 41 as illustrated in FIG. 7. Specifically, the frame connecting portions FX1 are each formed by fastening, via the fastening component 70, the first bottom portion 42a of the first storage 42 to a cross frame 14a of the frame 14 which horizontally extends. The portion of the first bottom portion 42a to which the fastening component 70 is fastened is lower than the surrounding portion. Furthermore, the other frame connecting portions FX1 are each formed by fastening, via the fastening component 70, a connecting piece 50R extending rearward from the upper portion 43d1 of the rear wall 43d in the storage forming component 40 to a cross frame 14b of the frame 14 which extends horizontally behind the cross frame 14a. As illustrated in FIG. 7, the storage forming component 40 may be higher than the frames 14a and 14b in the respective frame connecting portions FX1.

The front panel 16b, the side panels 16c, and the upper dashboard 21 are connected to the storage forming component 40. The front panel 16b, the side panels 16c, and the upper dashboard 21 may be connected to, for example, the car body 12 except the storage forming component 40.

The front panel 16b is connected to the front end of the storage forming component 40. As illustrated in FIG. 7, the storage forming component 40 includes a connecting piece 50F extending forward from the front end of the first front wall 42b. Front panel connecting portions FX2 are each formed by fastening, via the fastening component 70, the connecting piece 50F to an upper edge of the front panel 16b. In the front panel connecting portion FX2, the front panel 16b may be higher than the storage forming component 40.

The side panels 16c are connected to side ends of the storage forming component 40. As illustrated in FIG. 3, the storage forming component 40 includes connecting pieces 50A each extending laterally from the upper end of the side wall of the electrical component holder 45. Side panel connecting portions FX3 are each formed by fastening, via the fastening component 70, the connecting piece 50A to an upper edge of the side panel 16c. In the side panel connecting portions FX3, the side panels 16c may be higher than the storage forming component 40.

The side ends of the front panel 16b may extend to the sides of the storage forming component 40 and be connected to the connecting pieces 50A of the storage forming component 40, instead of the side panel connecting portions FX3, In this case, the side panels 16c may be connected to, for example, the car body 12, and the front panel 16b may cover connecting portions to the side panels 16c.

The upper dashboard 21 is connected to a rear end of the storage forming component 40. As illustrated in FIG. 3, the storage forming component 40 includes connecting pieces 50B extending laterally from the upper ends of the second side walls 43c. The front end of the connecting piece 50B is continuous to the upper end of the rear wall of the electrical component holder 45. Upper dashboard connecting portions FX4 are each formed by fastening, via the fastening component 70, the connecting piece 50B to an upper edge of the upper dashboard 21. In the upper dashboard connecting portions FX4, the upper dashboard 21 may be higher than the storage forming component 40.

The hood 17 covers the front panel connecting portions FX2, the side panel connecting portions FX3, and the upper dashboard connecting portions FX4. This reduces exposure of the front panel connecting portions FX2, the side panel connecting portions FX3, and the upper dashboard connecting portions FX4 in the vehicle 10. The hood 17 also covers the frame connecting portions FX1 in the first storage 42. The upper dashboard 21 covers the frame connecting portions FX1 behind the storage 41.

The storage forming component 40 extends from the front panel 16b to the upper dashboard 21 in the forward and backward direction. The storage forming component 40 extends from the left side panel 16c to the right side panel 16c in the vehicle-width direction. Most of the elements under the hood 17 consist of the storage forming component 40. For example, the storage forming component 40 is an integral part obtained by integrally molding a resin or a metal, etc., as a material using a die. The storage forming component functions as a partition that partitions the front internal space into a first space and a second space. The first space is a space surrounded by the storage forming component 40, and a space including the storage 41. The second space is a space outside the storage forming component 40, for example, a space below or behind the storage forming component 40.

The hood 17 is detachable from the vehicle 10. H ere, the hood 17 is detachable from the vehicle 10 without any tool. The vehicle 10 includes a hood attachment part to which the hood 17 is attached. The vehicle 10 includes, as the hood 17 attachment part, locking components 18, locking pawls 17d, first holes 51, and second holes 21f. A part of the hood 17 is attached to the first holes 51 through the locking components 18. Another part of the hood 17 is attached to the second holes 21f through the locking pawls 17d. The locking components 18 and the locking pawls 17d attach opposing ends of the hood 17. Here, the locking components 18 and the first holes 51 attach a front portion of the hood 17, and the locking pawls 17d and the second holes 21f attach a rear portion of the hood 17. The locking components 18 and the first holes 51 may attach the rear portion of the hood 17, and the locking pawls 17d and the second holes 21f may attach the front portion of the hood 17. Here, the hood 17 includes the locking components 18 and the locking pawls 17d, the storage forming component 40 includes the first holes 51, and the upper dashboard 21 includes the second holes 21f. The locking components 18, the locking pawls 17d, the first holes 51, and the second holes 21f may be included in other portions except the aforementioned portions. Furthermore, the hood 17 need not be detachable from the vehicle 10 but may have a structure in which an end closer to the rear car body can be opened and closed as an axis. In this case, the end closer to the rear car body may have, for example, a hinge structure. Furthermore, the opening and closing axis is not limited to the end closer to the rear car body but may be, for example, an end closer to the front car body, or right and left ends of the car body.

The vehicle 10 includes two pairs of the locking components 18 and the first holes 51. The two pairs of the locking components 18 and the first holes 51 are separated from each other in the vehicle-width direction. Furthermore, the vehicle 10 includes four pairs of the locking pawls 17d and the second holes 21.f. The four pairs of the locking pawls 17d and the second holes 21f are separated from each other in the vehicle-width direction. The number of the locking components 18 and the number of the locking pawls 17d are not limited to those described above but can be appropriately set.

Each of the locking components 18 includes a knob 18a and a hook 18b. The knob 18a is coupled to the hook 18b. The knobs 18a and the hooks 18b are rotatably attached to the hood 17. Here, attachment holes 17c are formed in the hood 17. The attachment holes 17c are formed into through holes that penetrate the upper surface 17a and the lower surface 17b, in a portion slightly behind the front edge of the hood 17. Each of the locking components 18 includes a fitting part 18c that fits into the attachment hole 17c. For example, the locking components 18 are provided as components separate from the hood body including the upper surface 17a and the lower surface 17b of the hood 17, and are integrated with the hood 17 by being incorporated into the hood body. The knob 18a protrudes upward from the fitting part 18c, and the hook 18b protrudes downward from the fitting part 18. The knob 18a is exposed on the upper surface 17a of the hood 17. The hook 18b is exposed on the lower surface 17b of the hood 17. With the fitting parts 18c being fitted into the attachment holes 17c, the knobs 18a and the hooks 18b are rotatable around the axis of the attachment holes 17cx with respect to the attachment holes 17c. Rotation of the knobs 18a by an operator can rotate the hooks 18b.

The first holes 51 are located between the storage 41 and the front panel connecting portions FX2, in the connecting pieces 50A of the storage forming component in the forward and backward direction. The first holes 51 are located at both outside portions of the three front panel connecting portions FX2 in the vehicle-width direction. The first holes 51 are located between the storage 41 and the headlight holders 45 in the vehicle-width direction. The first holes 51 are located at the outside portions of the three front panel connecting portions FX2. The hook 18b can pass through the first hole 51 with the knob 18a having a first rotation attitude. The hook 18b can be hooked to the first hole 51 with the knob 18a having a second rotation attitude. Here, the first hole 51 is formed into a long hole in the vehicle-width direction. The hook 18b is L-shaped when viewed from the horizontal direction. Rotating the knob 18a in a direction of an arrow sign A1 in FIG. 4 forms the first rotation attitude. Here, rotating the end of the L-shaped hook 18b coupled to the knob 18a in the direction of the arrow sign A1 in FIG. 6 extends the end in the vehicle-width direction. In this state, the hook 18b can pass through the first hole 51. Rotating the knob 18a in a direction of an arrow sign A2 in FIG. 4 forms the second rotation attitude. Here, rotating the end of the L-shaped hook 18b coupled to the knob 18a in the direction of the arrow sign A2 in FIG. 6 extends the end in the forward and backward direction. In this state, the end of the L-shaped hook 18b is locked at the lower surface of the perimeter of the first hole 51 in the forward and backward direction, in the storage forming component 40.

An upper surface 51a on which an upper opening of the first hole 51 in the storage forming component 40 is formed protrudes upward more than the surrounding portion thereof. The upper surfaces 51a support the hood 17 from the bottom. Here, the upper surfaces 51a are in contact with and support the perimeter of the attachment holes 17c of the hood 17 or the lower surface 17b with the locking components 18.

The locking pawls 17d protrude from the lower surface 17b of the hood 17. Here, the locking pawls 17d are integrally formed with the body of the hood 17. The two inner locking pawls 17d in the vehicle-width direction out of the four locking pawls 17d have an amount of protrusion larger in the forward and backward direction than those of the locking pawls 17d outside in the vehicle-width direction. For example, the two inner locking pawls 17d in the vehicle-width direction protrude more rearward than the rear edge of the hood 17, whereas the two locking pawls 17d outside in the vehicle-width direction do not protrude more rearward than the rear edge of the hood 17. The locking pawls 17d are inserted into the second holes 21f.

A gutter 21b is formed in the hood attachment part. The gutter 21b is formed by recessing the upper surface 21a of the upper dashboard 21 downward. The gutter 21b extends in the vehicle-width direction. The gutter 21b is formed at the front end of the upper dashboard 21. The gutter 21b is located below the windshield 26, and prevents the water running down the windshield 26 from entering the storage 41 (space under the hood 17).

The gutter 21b is a recess enclosed by a bottom portion 21c, a front wall 21d, and a rear wall 21e. The bottom portion 21c spreads almost in the horizontal direction. The front wall 21d protrudes upward from the front edge of the bottom portion 21c. The rear wall 21e protrudes upward from the rear edge of the bottom portion 21c. The bottom portion 21c, the front wall 21d, and the rear wall 21e are continuous in the vehicle-width direction. The gutter 21b has a shape with both ends falling more outward in the vehicle-width direction.

Drainage holes 54 are formed at both ends of the gutter 21b in the vehicle-width direction. Here, the storage forming component 40 covers both of the end portions of the gutter 21b formed in the upper dashboard 21. The storage forming component 40 includes side walls 53 at both ends of the gutter 21b. The drainage holes 54 are formed on the side walls 53 of the storage forming component 40. The upper dashboard 21 may include the side walls 53 with the drainage holes 54. Furthermore, the drainage holes 54 may be formed not on the side walls 53 but on the bottom portion 21c of the gutter 21b. The gutter 21b need not include the side walls 53 at both ends. Openings at both ends of the gutter 21b may be the drainage holes 54.

The upper dashboard 21 includes a windshield supporter 21h. The windshield supporter 21h is behind the upper end of the rear wall 21e. The windshield supporter 21h supports a lower end of the windshield 26.

An opening is formed between the rear edge of the hood 17 and the upper dashboard 21 facing the rear edge. The opening is between the windshield supporter 21h and the gutter 21b. As illustrated by an arrow sign A3 in FIG. 7, the water running down, for example, the windshield 26 enters below the hood 17 through the opening and reaches the gutter 21b. The water reaching the gutter 21b moves toward both ends in the width direction along, for example, the bottom portion 21e of the gutter 21b, and is drained downward through the drainage holes 54.

The second holes 21f are formed on the rear wall 21e of the gutter 21b. Lower edges of the second holes 21f are higher than a lower edge of the rear wall 21e that is continuous to the bottom portion 21c.

Hood supporters 21g protrude upward from the bottom portion 21c of the gutter 21b. The hood supporters 21g support the rear edge of the hood 17. The hood supporters 21g are formed apart from the front wall 21d or the rear wall 21e to avoid the gutter 21b from being completely blocked.

The four hood supporters 21g are formed apart in the vehicle-width direction. The four second holes 21f are formed apart from the hood supporters 21g in the vehicle-width direction. The two hood supporters 21g and the two second holes 21f are formed from the middle toward the outside in the vehicle-width direction. The hood supporter 21g and the second hole 21f are alternately formed. The two second holes 21f are located at portions more outside than the two hood supporters 21g the outermost in the vehicle-width direction. The remaining second holes 21f are formed between the hood supporters 21g the outermost in the vehicle-width direction and the hood supporters 21g inner than the hood supporters 21g the outermost.

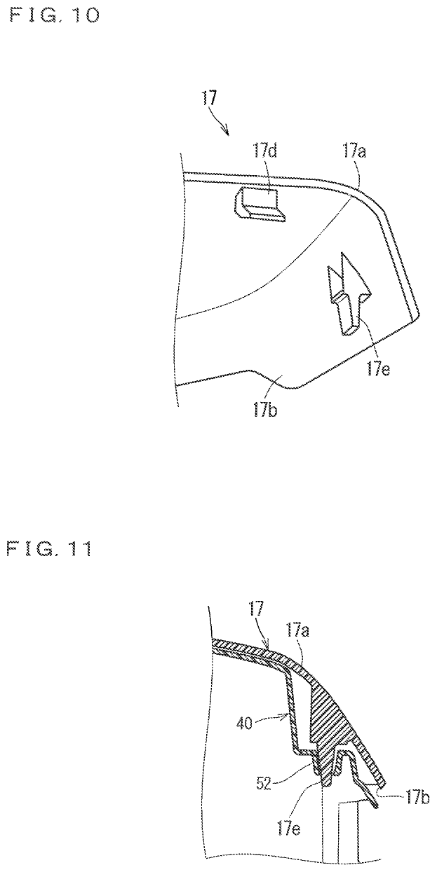

The storage forming component 40 also includes hood supporters 52. The hood supporters 52 are behind the side panel connecting portions FX3. The hood 17 includes receiving parts 17e to be supported by the hood supporters 52. The receiving parts 17e protrude downward from the lower surface 17b of the hood body. In the example of FIG. 6, holes are formed on the receiving parts 17e of the hood 17. The hood supporters 52 are inserted into the holes of the receiving parts 17e. The hood supporters 52 may be, for example, rubber dampers or resin clips. The receiving parts 17e and the hood supporters 52 are not limited to these shapes. As illustrated in FIGS. 10 and 11, the receiving part 17e may be pawl-shaped for fastening the receiving part 17e to a hole of the hood supporter 52 in a plug-in manner.

Connecting pieces 21i protrude forward from the front wall 21d of the gutter 21b in the upper dashboard 21. Fastening the fastening components 70 to the connecting pieces 21i forms the upper dashboard connecting portions FX4. The upper dashboard connecting portions FX4 include a pair of the right and left connecting pieces 21i to each of which the two fastening components 70 are fastened.

The storage forming component 40 includes a first rib 49. The first rib 49 is formed around an upper edge of the storage 41. Here, the first rib 49 includes a portion protruding upward from the perimeter of the upper edge of the first front wall 42b, a portion protruding upward from the perimeter of the upper edge of a portion of the first side wall 42c except the recess 47, and a portion protruding upward from the perimeter of the upper edge of the second side wall 43c.

The hood 17 includes a second rib 17f. The second rib 17f protrudes from the lower surface 17b of the hood 17. The first rib 49 faces the second rib 17f apart in the horizontal direction. Here, the first rib 49 is closer to the storage 41 than the second rib 17f. In a portion at which the first rib 49 faces the second rib 17f, an end of the first rib 49 and an end of the second rib 17f overlap in the horizontal direction. In other words, the lower end of the second rib 17f is lower than the upper end of the first rib 49 in the portion at which the first rib 49 faces the second rib 17f. This does not create any space between the first rib 49 and the second rib 17f when viewed from the horizontal direction as illustrated in FIG. 7. In the portion at which the first rib 49 faces the second rib 171f the end of the first rib 49 and the end of the second rib 17f may be formed without any overlap in the horizontal direction.

Here, the second rib 17f is a continuous rectangle. The second rib 17f includes a front rib 17f1, a rear rib 17f2, and a pair of side ribs 17f3. The front rib 17f1 and the rear rib 17f2 extend in the vehicle-width direction, at a distance in the forward and backward direction. The pair of side ribs 17f3 extend in the forward and backward direction, at a distance in the vehicle-width direction. The pair of side ribs 17f3 connects the ends of the front rib 17f1 to the ends of the rear rib 17f2 in the vehicle-width direction. The front rib 17f1 and the pair of side ribs 1713 face the first rib 49.

The upper dashboard 21 includes a third rib 21j. The third rib 21j protrudes upward from the perimeter of the upper edge of the front wall 21d of the gutter 21b. Here, the third rib 21j is located between the pair of connecting pieces 21i. The front surface of both ends of the third rib 21j in the vehicle-width direction faces an end face of the first rib 49. A portion of the second rib 17f extending rearward in the vehicle-width direction is behind the third rib 21j.

The gutter 21b is, for example, at a position approximately identical to the rear edge of the second bottom portion 43a of the second storage 43 in the forward and backward direction. The upper portion 43d1 of the rear wall 43d of the second storage 43 is behind the gutter 21b. As illustrated in FIGS. 7 and 8, an opening OP is formed between the upper portion 43d1 of the rear wall 43d of the second storage 43 and a lower surface of the upper dashboard 21. This can pull, for example, a cable from the space in the dashboard 20 into the storage 41 through the opening. The upper portion 43d1 of the rear wall 43d may reach the lower surface of the upper dashboard 21 to avoid formation of the opening OP.

### [Advantages]

The hood 17 covers the storage 41 and the electrical components 60 in the vehicle with the aforementioned structure, Thus, opening the hood 17 can access not only the storage 41 but also the electrical components 60.

Furthermore, the electrical components 60 include the headlights 60. Thus, opening the hood 17 can access not only the storage 41 but also the headlights 60.

The hood 17 is detachable. The hood 17 is not of a type in which one end thereof is connected to the car body 12 through a hinge, but of a type allowing complete removal from the car body 12. Consequently, the detachable hood 17 can bring about the absence of the hood 17 above the storage 41 and the electrical components 60.

The hook 18b can pass through the first hole 51 with the knob 18a having a first rotation attitude, and the hook 18b can be hooked to the first hole 51 with the knob 18a having a second rotation attitude. Thus, rotating the knobs 18a can lock and unlock the hood 17.

The vehicle 10 further includes: the locking pawl 17d disposed at an end of the hood 17, the end being opposite to an end of the hood 17 at which the locking component 18 is disposed; and the second hole 21f into which the locking pawl 17d is inserted. Thereby, the locking components 18 and the locking pawls 17d can attach the hood 17 to the vehicle 10 without any tool.

The storage forming component 40 includes the electrical component holders 45 holding the electrical components 60. This can integrate the storage 41 and the electrical component holders 45 into a single component, and suppress an increase in the number of components.

The storage forming component 40 further includes the waterproof wall 48 that partitions the storage 41 and the electrical component holders 45. The waterproof wall 48 can prevent water from entering the electrical component holders 45.

Furthermore, the electrical components 60 include the pair of right and left headlights 60, and the electrical component holders 45 include the pair of headlight holders disposed at both sides of the storage 41. Consequently, the empty space between the pair of headlight holders 45 at both sides can be used as the storage 41.

Furthermore, the storage forming component 40 includes the first rib 49 formed around an upper edge of the storage 41. The first rib 49 can prevent water from entering the storage 41.

Furthermore, the hood 17 includes the second rib 17f facing the first rib 49 at a lateral side of the first rib 49, the second rib 17f protruding from the lower surface 17b. The first rib 49 and the second rib 17f can generate a labyrinth structure that can more reliably prevent water from entering the storage 41.

Furthermore, the gutter 21b is formed in the hood attachment part, the gutter 21b extending in the vehicle-width direction. Here, the wall in which the second holes 21f are formed is the rear wall 21e of the gutter 21b. The gutter 21b can prevent water from entering the storage 41.

Furthermore, the drainage holes 54 are formed in the gutter 21b. This can drain the water flowing through the gutter 21b downward from the drainage holes 54.

The gutter 21b has a shape with both ends falling more outward in the vehicle-width direction, and the drainage holes 54 are formed at the ends of the gutter 21b, This can smoothly drain the water from the gutter 21b to the drainage holes 54.

Furthermore, the storage 41 includes the first storage 42 with the first bottom portion 42a, and the second storage 43 with the second bottom portion 43a lower than the first bottom portion 42a. The storage 41 can be deeper with the first storage 42 and the second storage 43, while avoiding the frames 14a around the storage 41. Thus, the bag LG2 relatively longer can be housed in the second storage 43.

Furthermore, the hood 17 covers the front panel connecting portions FX2 between the storage forming component 40 and the front panel 16b. Consequently, the hood 17 can hide the front panel connecting portions FX2.

Furthermore, the hood 17 covers the side panel connecting portions FX3 between the storage forming component 40 and the side panels 16c. Consequently, the hood 17 can hide the side panel connecting portions FX3.

Furthermore, the hood 17 covers the upper dashboard connecting portions FX4 between the storage forming component 40 and the upper dashboard 21. Consequently, the hood 17 can hide the upper dashboard connecting portions FX4,

### [Modifications]

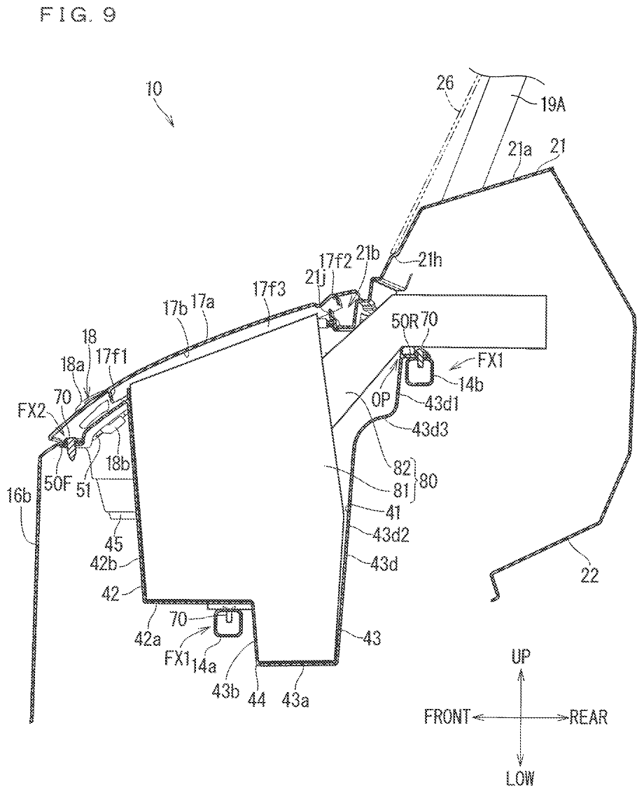

Another example usage of the storage 41 will be described. FIG. 9 illustrates a state in which a speaker device 80 is housed in the storage 41. FIG. 9 illustrates a cross-sectional view identical to that in FIG. 7 except the speaker device 80.

The vehicle 10 further includes the speaker device 80 provided separately from the electrical components 60. The speaker device 80 includes a speaker body 81 and a pipe 82. The storage 41 houses the speaker body 81. The pipe 82 extending rearward from the speaker body 81 propagates the sound of the speaker body 81 to the occupant space in the vehicle 10.

Since the storage 41 houses the speaker body 81, the speaker body 81 with a relatively larger size can be adopted. Furthermore, protrusion of the rear end of the pipe 82 toward the occupant space rather than the storage 41 facilitates propagation of the sound of the speaker body 81 to the occupants.

The pipe 82 extends rearward through the opening OP between the upper portion 43d1 of the rear wall 43d of the second storage 43 and the lower surface 17b of the upper dashboard 21. The rear end of the pipe 82 may reach the occupant space through the dashboard 20 or be located in the dashboard 20 without reaching the occupant space. The pipe 82 may include a cable extending from the speaker body 81 or a cable connected to the speaker body. The cable may extend between the space in the dashboard 20 and the storage 41 through the opening OP. The cable may connect a device disposed in the dashboard 20 to the speaker body.

The speaker device 80 may be dedicatedly designed according to the shape of the storage 41. The speaker device 80 may be provided as, for example, optional equipment of the vehicle 10.

Passenger transport vehicles may be, for example, versatile small vehicles suitable for traveling through limited off-road areas rather than traveling through public roads at fast speeds. Off-road vehicles may be, for example, side-by-side vehicles. The side-by-side vehicles are, for example, small vehicles suitable for all terrain travel, particularly, off-road travel, and vehicles in which occupants can be seated side by side. The side-by-side vehicles may be, for example, multipurpose off-highway utility vehicles (MOHUVs) defined by ANSI/OPEI B71.9-2016, and recreational off-highway vehicles defined by ANSI/ROHVA 1-2016.

The vehicle 10 may be a passenger transport vehicle. The passenger transport vehicle is a vehicle designed to travel at low speeds within a limited area. Examples of the limited area may include limited community areas, and private roads and private lands (e.g., golf courses and parks) except public roads. The limited community areas may be areas provided for use by community residents. The community areas are, for example, areas including houses and public facilities (e.g., schools and hospitals), and are areas in which the passenger transport vehicle designed to travel through non-public highways are permitted to travel at low speeds. The low speeds are, for example, speeds with upper limits ranging from 20 mph to 30 mph. The passenger transport vehicles include personal transport vehicles (PTVs) in accordance with ANSI/ILTVA Z135, and golf carts in accordance with ANSI/ILTVA Z130.1. Furthermore, the passenger transport vehicles include personal transportation electric vehicles.

### [Appendixes]

This application discloses the following aspects.

A vehicle according to a first aspect comprises: a storage forming component disposed in a front portion of the vehicle, the storage forming component including a storage; a hood covering a top of the storage; and at least one electrical component covered by the hood.

Opening the hood in this vehicle can access not only the storage but also the electrical component.

A second aspect is the vehicle according to the first aspect, wherein the at least one electrical component comprises a headlight.

In this case, opening the hood can access not only the storage but also the headlight.

A third aspect is the vehicle according to the first or second aspect, wherein the hood is detachable.

In this case, the detachable hood can bring about the absence of the hood above the storage and the electrical component.

A fourth aspect is the vehicle according to one of the first to third aspects, the vehicle further comprising: a locking component including a hook and a knob coupled to the hook, the locking component being attached to the hood so that the knob and the hook are rotatable; and a first hole through which the hook can pass with the knob having a first rotation attitude, and to which the hook can be hooked with the knob having a second rotation attitude.

In this case, rotating the knob can lock and unlock the hood.

A fifth aspect is the vehicle according to the fourth aspect, the vehicle farther comprising: a locking pawl disposed at an end of the hood, the end being opposite to an end of the hood at which the locking component is disposed; and a second hole into which the locking pawl is inserted.

In this case, the locking component and the locking pawl can attach the hood to the car body without any tool.

A sixth aspect is the vehicle according to one of the first to fifth aspects, wherein the storage forming component includes at least one electrical component holder holding the at least one electrical component.

This can integrate the storage and the electrical component holder into a single component, and suppress an increase in the number of components.

A seventh aspect is the vehicle according to the sixth aspect, wherein the storage forming component includes a waterproof wall that partitions the storage and the at least one electrical component holder.

In this case, the waterproof wall can prevent water from entering the electrical component holder.

An eighth aspect is the vehicle according to the sixth or seventh aspect, wherein the at least one electrical component comprises a pair of right and left headlights, and the at least one electrical component holder comprises a pair of headlight holders disposed at both sides of the storage.

In this case, the empty space between the pair of headlight holders at both sides can be used as the storage.

A ninth aspect is the vehicle according to one of the first to eighth aspects, wherein the storage forming component includes a first rib formed around an upper edge of the storage.

In this case, the first rib can prevent water from entering the storage.

A tenth aspect is the vehicle according to the ninth aspect, wherein the hood includes an upper surface, a lower surface, and a second rib facing the first rib at a lateral side of the first rib, the second rib protruding from the lower surface.

In this case, the first rib and the second rib can generate a labyrinth structure that can more reliably prevent water from entering the storage.

An eleventh aspect is the vehicle according to one of the first to tenth aspects, the vehicle comprising a hood attachment part to which the hood is attached, wherein a gutter is formed in the hood attachment part, the gutter extending in a vehicle-width direction.

In this case, the gutter can prevent water from entering the storage.

A twelfth aspect is the vehicle according to the eleventh aspect, wherein at least one drainage hole is formed in the gutter.

This can drain, the water flowing through the gutter downward from the drainage hole.

A thirteenth aspect is the vehicle according to the twelfth aspect, wherein the gutter has a shape with both ends falling more outward in the vehicle-width direction, and the at least one drainage hole comprises drainage holes formed at the ends of the gutter.

This can smoothly drain the water from the gutter to the drainage holes.

A fourteenth aspect is the vehicle according to one of the first to thirteenth aspects, wherein the storage includes a first storage with a first bottom portion, and a second storage with a second bottom portion lower than the first bottom portion.

In this case, the storage can be deeper with the first storage and the second storage, while avoiding the frames around the storage. Thus, a relatively longer bag can be housed in the second storage.

A fifteenth aspect is the vehicle according to one of the first to fourteenth aspects, the vehicle further comprising a speaker device including a speaker body housed in the storage, and a pipe extending rearward from the speaker body and propagating sound of the speaker body to an occupant space in the vehicle, the speaker device being provided separately from the at least one electrical component, wherein a rear end of the pipe protrudes toward the occupant space rather than the storage.

Since the storage houses the speaker body, the speaker body with a relatively larger size can be adopted. The pipe facilitates propagation of the sound of the speaker body to the occupants.

A sixteenth aspect is the vehicle according to one of the first to fifteenth aspects, the vehicle further comprising a front panel connected to a front end of the storage forming component and giving appearance of the vehicle, wherein the hood covers a connecting portion between the storage forming component and the front panel.

In this case, the hood can hide the connecting portion between the storage forming component and the front panel.

A seventeenth aspect is the vehicle according to one of the first to sixteenth aspects, the vehicle further comprising side panels connected to side ends of the storage forming component and giving appearance of the vehicle, wherein the hood covers connecting portions between the storage forming component and the side panels.

In this case, the hood can hide the connecting portions between the storage forming component and the side panels.

An eighteenth aspect is the vehicle according to one of the first to seventeenth aspects, the vehicle further comprising an upper dashboard connected to a rear end of the storage forming component, wherein the hood covers a connecting portion between the storage forming component and the upper dashboard.

In this case, the hood can hide the connecting portion between the storage forming component and the upper dashboard.

A nineteenth aspect is the vehicle according to one of the first to fifteenth aspects, the vehicle further comprising: a front panel connected to a front end of the storage forming component and giving appearance of the vehicle; side panels connected to side ends of the storage forming component and giving appearance of the vehicle; and an upper dashboard connected to a rear end of the storage forming component, wherein the hood covers a connecting portion between the storage forming component and the front panel, connecting portions between the storage forming component and the side panels, and a connecting portion between the storage forming component and the upper dashboard.

In this case, the hood can hide the connecting portions between the storage forming component and each of the front panel, the side panels, and the upper dashboard.

The foregoing description is in all aspects illustrative and does not restrict the present invention. Numerous modifications and variations that have not yet been exemplified are devised without departing from the scope of the present invention.

1. A vehicle, comprising:
a storage forming component disposed in a front portion of the vehicle, the storage forming component including a storage;
a hood covering a top of the storage; and
at least one electrical component covered by the hood.

2. The vehicle according to claim 1,
wherein the at least one electrical component includes a headlight.

3. The vehicle according to claim 1,
wherein the hood is detachable.

4. The vehicle according to claim 1, further comprising:
a locking component including a hook and a knob coupled to the hook, the locking component being attached to the hood so that the knob and the hook are rotatable; and
a first hole through which the hook can pass with the knob having a first rotation attitude, and to which the hook can be hooked with the knob having a second rotation attitude.

5. The vehicle according to claim 4, further comprising:
a locking pawl disposed at an end of the hood, the end being opposite to an end of the hood at which the locking component is disposed; and
a second hole into which the locking pawl is inserted.

6. The vehicle according to claim 1,
wherein the storage forming component includes at least one electrical component holder holding the at least one electrical component.

7. The vehicle according to claim 6,
wherein the storage forming component includes a waterproof wall that partitions the storage and the at least one electrical component holder.

8. The vehicle according to claim 6,
wherein the at least one electrical component includes a pair of right and left headlights, and
the at least one electrical component holder includes a pair of headlight holders disposed at both sides of the storage.

9. The vehicle according to claim 1,
wherein the storage forming component includes a first rib formed around an upper edge of the storage.

10. The vehicle according to claim 9,
wherein the hood includes an upper surface, a lower surface, and a second rib facing the first rib at a lateral side of the first rib, the second rib protruding from the lower surface.

11. The vehicle according to claim 1, comprising
a hood attachment part to which the hood is attached,
wherein a gutter is formed in the hood attachment part, the gutter extending in a vehicle-width direction.

12. The vehicle according to claim 11,
wherein at least one drainage hole is formed in the gutter.

13. The vehicle according to claim 12,
wherein the gutter has a shape with both ends falling more outward in the vehicle-width direction, and
the at least one drainage hole comprises drainage holes formed at the ends of the gutter.

14. The vehicle according to claim 1,
wherein the storage includes a first storage with a first bottom portion, and a second storage with a second bottom portion lower than the first bottom portion.

15. The vehicle according to claim 1, further comprising
a speaker device including a speaker body housed in the storage, and a pipe extending rearward from the speaker body and propagating sound of the speaker body to an occupant space in the vehicle, the speaker device being provided separately from the at least one electrical component,
wherein a rear end of the pipe protrudes toward the occupant space rather than the storage.

16. The vehicle according to claim 1, further comprising
a front panel connected to a front end of the storage forming component and giving appearance of the vehicle,
wherein the hood covers a connecting portion between the storage forming component and the front panel.

17. The vehicle according to claim 1, further comprising
side panels connected to side ends of the storage forming component and giving appearance of the vehicle,
wherein the hood covers connecting portions between the storage forming component and the side panels.

18. The vehicle according to claim 1, further comprising
an upper dashboard connected to a rear end of the storage forming component,
wherein the hood covers a connecting portion between the storage forming component and the upper dashboard.

19. The vehicle according to claim 1, further comprising:
a front panel connected to a front end of the storage forming component and giving appearance of the vehicle;
side panels connected to side ends of the storage forming component and giving appearance of the vehicle; and
an upper dashboard connected to a rear end of the storage forming component,
wherein the hood covers a connecting portion between the storage forming component and the front panels connecting portions between the storage forming component and the side panels, and a connecting portion between the storage forming component and the upper dashboard.
